(19) United States
(12) Patent Application Publication
(10) Pub. No.: US 2025/0119916 A1
(43) Pub. Date: Apr. 10, 2025

(54) TECHNIQUES FOR CONFIGURING MULTIPLEXING OF UPLINK CONTROL INFORMATION IN WIRELESS COMMUNICATIONS

(71) Applicant: QUALCOMM Incorporated, San Diego, CA (US)

(72) Inventors: Yi HUANG, San Diego, CA (US); Jing SUN, San Diego, CA (US); Mostafa KHOSHNEVISAN, San Diego, CA (US); Gabi SARKIS, San Diego, CA (US)

(21) Appl. No.: 18/483,804

(22) Filed: Oct. 10, 2023

(51) Int. Cl. H04W 72/21; H04W 72/1268; H04W 72/232

(52) U.S. Cl. CPC H04W 72/21; H04W 72/1268; H04W 72/232

(57) ABSTRACT

Aspects described herein relate to receiving, from a network node, downlink control information (DCI) including a parameter having a value indicating whether uplink control information (UCI) is to be multiplexed with an uplink control channel or an uplink shared channel, multiplexing, based on the value, UCI with one of the uplink control channel or the uplink shared channel, and transmitting one of the uplink control channel or the uplink shared channel multiplexed with the UCI. Other aspects relate to generating the DCI and demultiplexing the UCI.

### FIELD OF THE DISCLOSURE

Aspects of the present disclosure relate generally to wireless communication systems, and more particularly, to techniques for multiplexing uplink control information (UCI).

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to receive, from a network node, downlink control information (DCI) including a parameter having a value indicating whether uplink control information (UCI) is to be multiplexed with an uplink control channel or an uplink shared channel, multiplex, based on the value, UCI with one of the uplink control channel or the uplink shared channel, and transmit one of the uplink control channel or the uplink shared channel multiplexed with the UCI.

In another aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to generate DCI including a parameter having a value indicating whether UCI is to be multiplexed with an uplink control channel or an uplink shared channel, and transmit, for a user equipment (UE), the DCI.

In another aspect, a method for wireless communication at a UE is provided that includes receiving, from a network node, DCI including a parameter having a value indicating whether UCI is to be multiplexed with an uplink control channel or an uplink shared channel, multiplexing, by the UE and based on the value, UCI with one of the uplink control channel or the uplink shared channel, and transmitting one of the uplink control channel or the uplink shared channel multiplexed with the UCI.

In another aspect, a method for wireless communication at a network node is provided that includes generating DCI including a parameter having a value indicating whether UCI is to be multiplexed with an uplink control channel or an uplink shared channel, and transmitting, for a UE, the DCI.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for multiplexing uplink control information (UCI) in an uplink control channel or with an uplink shared channel, in accordance with aspects described herein;

FIG. 6 is a flow chart illustrating an example of a method for indicating whether to multiplex UCI in an uplink control channel or with an uplink shared channel, in accordance with aspects described herein;

FIG. 7 illustrates examples of resource allocations for multiplexing UCI on an uplink shared channel, in accordance with aspects described herein;

FIG. 8 illustrates examples of resource allocations for multiplexing UCI on multiple uplink shared channels, in accordance with aspects described herein; and

FIG. 9 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to configuring a device for multiplexing uplink control information (UCI) with an uplink control channel or an uplink shared channel. For example, a device, such as a user equipment (UE) in fifth generation (5G) new radio (NR) or other wireless communication technologies, can be scheduled (e.g., by a network node, such as a gNB) for communicating over an uplink control channel, such as physical uplink control channel (PUCCH) or an uplink shared channel, such as physical uplink shared channel (PUSCH). In some examples, the UE can multiplex UCI with other PUCCH transmissions or a PUSCH transmission for transmitting to the network node. In one example, the device can multiplex multiple UCI transmissions for transmitting over a single PUCCH, though multiple PUCCH resources for transmitting the UCI may be scheduled. In another example, if the UCI or corresponding PUCCH overlaps PUSCH resources, the device can multiplex the UCI with the PUSCH to conserve radio resources, decrease possible interference among the PUCCH and PUSCH transmissions, etc. For example, where overlapping or parallel PUCCH or PUSCH transmission are scheduled on the same component carrier (CC), intermodulation and/or out-of-band emissions may increase, which may cause the UE to reduce transmission power and accordingly decrease uplink coverage.

Accordingly, multiplexing of PUCCH (e.g., with other PUCCHs and/or PUSCH) is introduced. In 5G NR, devices perform a sequential procedure to determine whether to multiplex UCI with other PUCCHs and/or PUSCH. For example, the device can determine whether scheduled PUCCHs overlap in the time domain, and if so, can perform an iterative pseudo code process to determine a the final PUCCH for multiplexing UCI. Similarly, the device can determine whether scheduled PUCCHs overlap with one or more PUSCHs in the time domain, and if so, can perform a set of rules to prioritize PUSCHs and select a PUSCH with highest priority as the final PUSCH for multiplexing UCI. Specifically, in 5G NR, for UCI multiplexing, within a PUCCH group, on PUSCH, the device can perform the following two steps: 1) UCI in overlapped PUCCH transmissions is multiplexed into one PUCCH resource (resource Z), which can be per PUCCH slot; and 2) UCI, that does not include scheduling request (SR), in Z is multiplexed into one PUSCH, if Z overlaps with at least one PUSCH, following the following priorities (sequentially from high to low): First priority—PUSCH with aperiodic channel state information (A-CSI) as long as it overlaps with Z; Second priority—earliest PUSCH slot(s) based on the start of the slot(s). Then, if there are still multiple PUSCHs overlap with Z in the earliest PUSCH slot(s): Third priority-Dynamic grant PUSCHs have higher priority than PUSCHs configured by respective ConfiguredGrantConfig or semiPersistentOnPUSCH; Fourth priority-PUSCHs on serving cell with smaller serving cell index have higher priority than PUSCHs on serving cell with larger serving cell index; Fifth priority-Earlier PUSCH transmission have higher priority than later PUSCH transmission.

There may be some ambiguity, however, with respect to which PUCCH to use to multiplex UCI. For example, the UE can select a PUCCH having sufficient size for transmitting the multiplexed UCI, but multiple PUCCHs may have similar or sufficient size. For example, based on a number of bits in merged UCI, the UE can find a corresponding PUCCH resource set (a new PUCCH resource set), and can reinterpret the PUCCH resource indicator (PRI) associated with the PUCCH for the UCI in the new PUCCH resource set and point to a new PUCCH resource in the set. Size ambiguity due to missing downlink control information (DCI) could also lead to ambiguity on the new PUCCH resource. In this example, the new PUCH resource and an old PUCCH resource could end up with different starting and ending symbols. Moreover, as described, merging the UCI can be an iterative approach. The new PUCCH resource set for the merged UCIs may overlap with another PUCCH resource set, which can trigger a new round of merging and end up with a new floating PUCCH. Similarly, for example, there may be ambiguity on which PUSCH is used to carry multiplexed UCI due to the UE missing receiving of a DCI. In one example, ambiguity in which PUCCH to use, as described above, can lead to ambiguity in the set of candidate PUSCHs for UCI multiplexing. In addition, missing the DCI scheduling PUSCH can leave to ambiguity in the set of PUSCH candidates. Moreover, the rules that the UE verifies in selecting the final PUSCH to carry the merged UCI can be complicated.

In accordance with aspects described herein, DCI can include an parameter specifying whether UCI is to be multiplexed with an uplink control channel (e.g., PUCCH) or an uplink shared channel (PUSCH), and the UE can accordingly multiplex the UCI with the uplink control channel or uplink shared channel based on the indicated specified in the UCI. In one example, DCI (e.g., certain DCI formats for uplink grants or downlink grants, etc.) can be extended to include a one bit indicator for this purpose. For example, for multiplexing with PUSCH, the multiplexing can be slot based, such that UCI occurring within a slot can be multiplexed with the PUSCH, or can be boundary based, such that UCI corresponding to a PUCCH that overlaps in time with the PUSCH can be multiplexed with the PUSCH. For multiplexing with PUCCH, for example, a dedicated PUCCH resource can be used for multiplexed UCI or a dedicated resource pool can be specified, from which a PUCCH resource can be selected for multiplexed UCI. In yet another example, for PUCCH multiplexing, a set indicator can be used to indicate which scheduled PUCCH resource to select for PUCCH multiplexing. In another example, the parameter in the DCI can include a downlink assignment index (DAI) indicated in the DCI. In an example, a DAI value of zero can indicate that UCI is not multiplexed on the associated PUSCH, and a value greater than zero can indicated that UCI is multiplexed on the associated PUSCH and/or can indicate the number of UCI bits (e.g., hybrid automatic repeat/request (HARQ)-acknowledgement (ACK) bits the UE is to multiplex on the PUSCH).

Aspects described herein allow for indicating in DCI whether the UCI is multiplexed with PUCCH or PUSCH, which can allow the UE to perform multiplexing without necessarily having to perform the iterative code for finding a PUCCH for multiplexing UCI or the complicated rules for determining PUSCH to carry the multiplexed UCI. For example, where the UCI is to be multiplexed with PUSCH, the DCI scheduling the PUSCH can indicate that the UCI is to be multiplexed with that PUSCH being scheduled. In any case, this can improve performance of the UE in determining which resources over which to multiplex UCI and/or can improve UCI multiplexing performance by resolving potential ambiguities between PUCCH and/or PUSCH resource occasions for multiplexing the UCI.

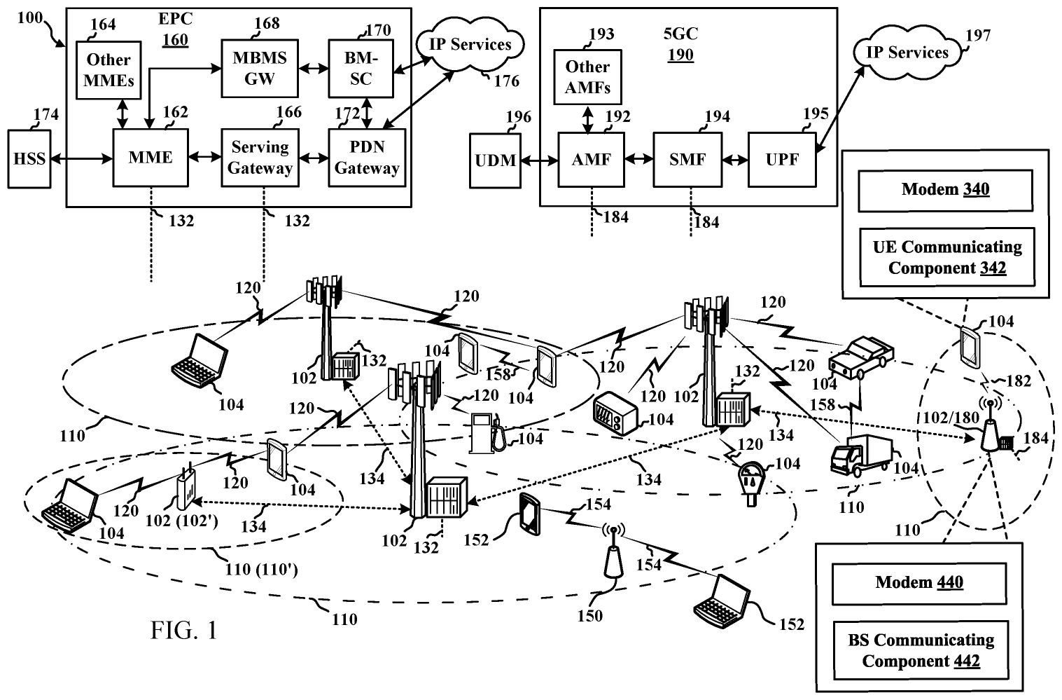

The described features will be presented in more detail below with reference to FIGS. 1-9.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for multiplexing UCI with an uplink control channel or an uplink shared channel based on a parameter in DCI, in accordance with aspects described herein. In addition, some nodes may have a modem 440 and BS communicating component 442 for indicating whether to multiplex UCI in an uplink control channel or with an uplink shared channel, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE communicating component 342 can multiplex UCI in an uplink control channel or with an uplink shared channel based on a parameter received from a base station 102, gNB 180, or other network node. For example, the parameter may be received in DCI. In some examples, the DCI can correspond to a resource grant (e.g., an uplink grant) for the uplink shared channel, though the DCI may also correspond to a resource grant for the uplink control channel or one or more downlink channels. UE communicating component 342 can accordingly multiplex the UCI in the uplink control channel or with the uplinks hared channel based on the parameter. In an example, BS communicating component 442 can transmit the parameter to the UE 104 (e.g., in DCI). In another example, BS communicating component 442 may also demultiplex the UCI from the uplink control channel or uplink shared channel based on the parameter.

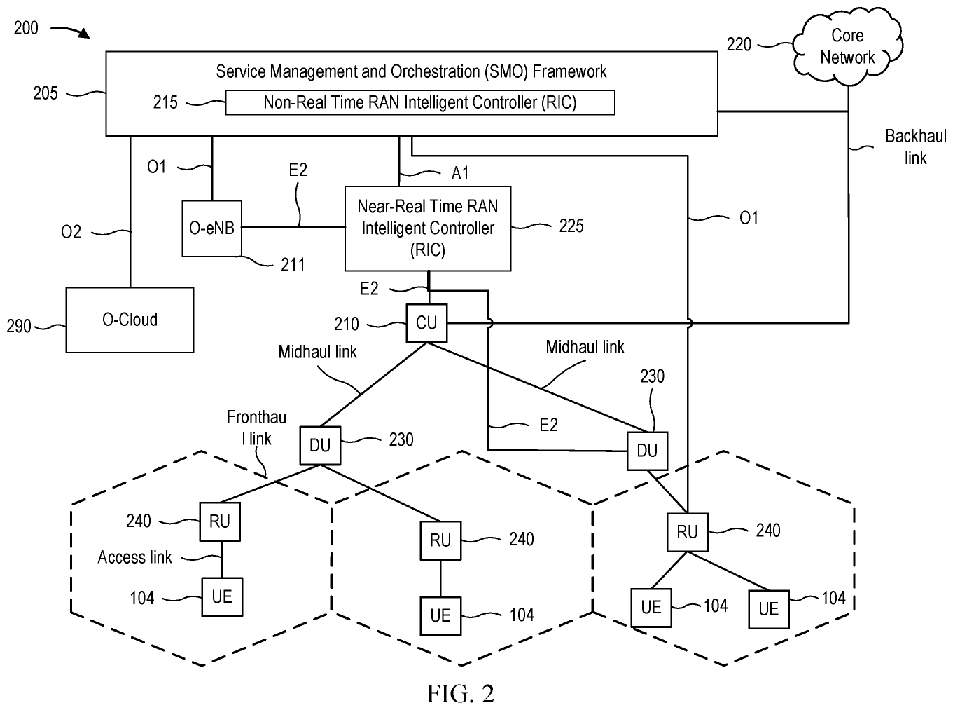

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

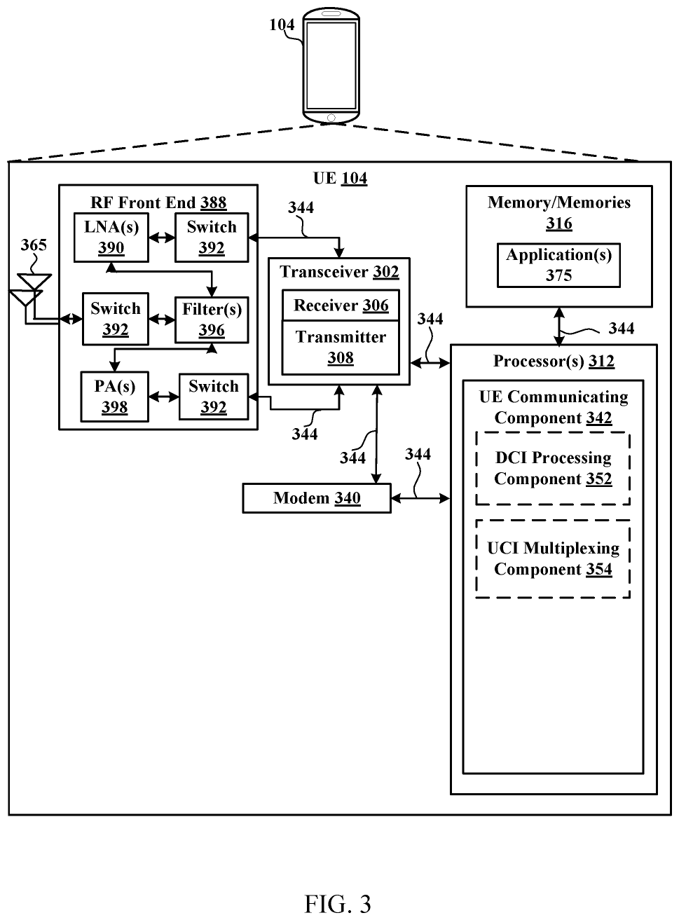

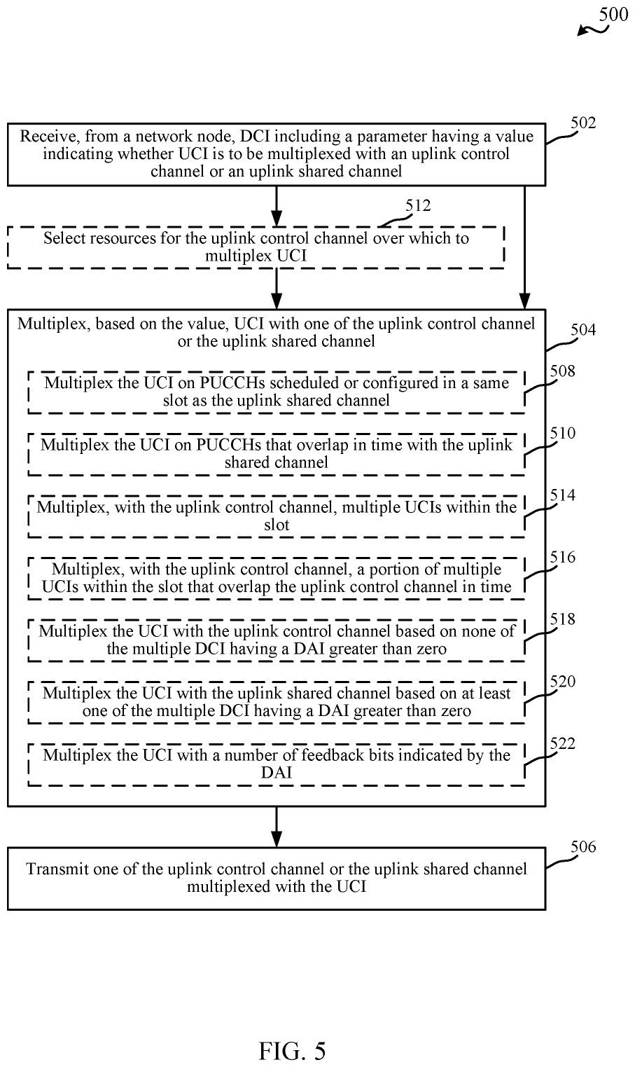

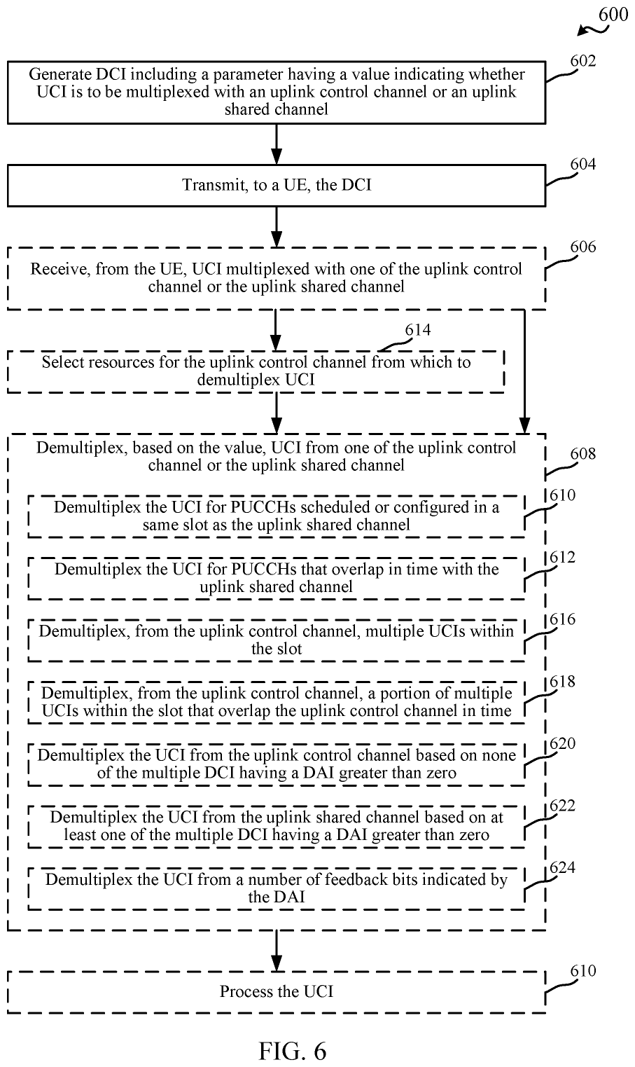

Turning now to FIGS. 3-9, aspects are depicted with reference to one or more components and one or more methods that may perform the actions or operations described herein, where aspects in dashed line may be optional. Although the operations described below in FIGS. 5 and 6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or UE communicating component 342 for multiplexing UCI with an uplink control channel or an uplink shared channel based on a parameter in DCI, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory/memories 316 may be configured to store data used herein and/or local versions of applications 375 or UE communicating component 342 and/or one or more of its subcomponents being executed by at least one processor 312.

Memory/memories 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory/memories 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a DCI processing component 352 for receiving and/or processing DCI received from a network node, and/or a UCI multiplexing component 354 for multiplexing UCI in an uplink control channel or with an uplink shared channel based on a parameter in the DCI.

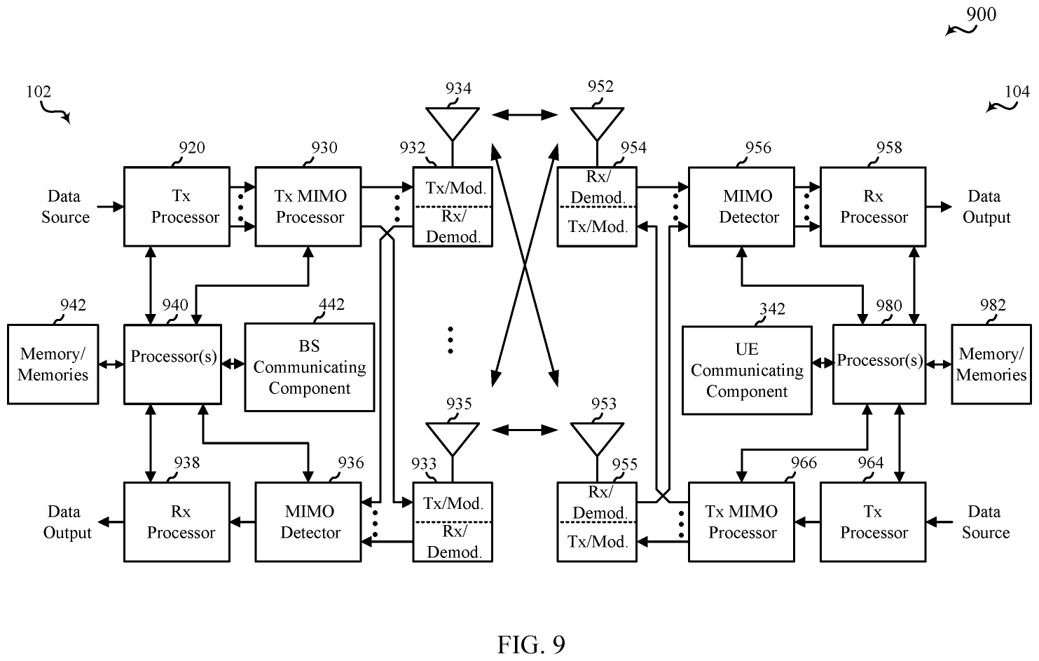

In an aspect, the processor(s) 312 may correspond to one or more of the processors described in connection with the UE in FIG. 9. Similarly, the memory/memories 316 may correspond to the one or more memories described in connection with the UE in FIG. 9.

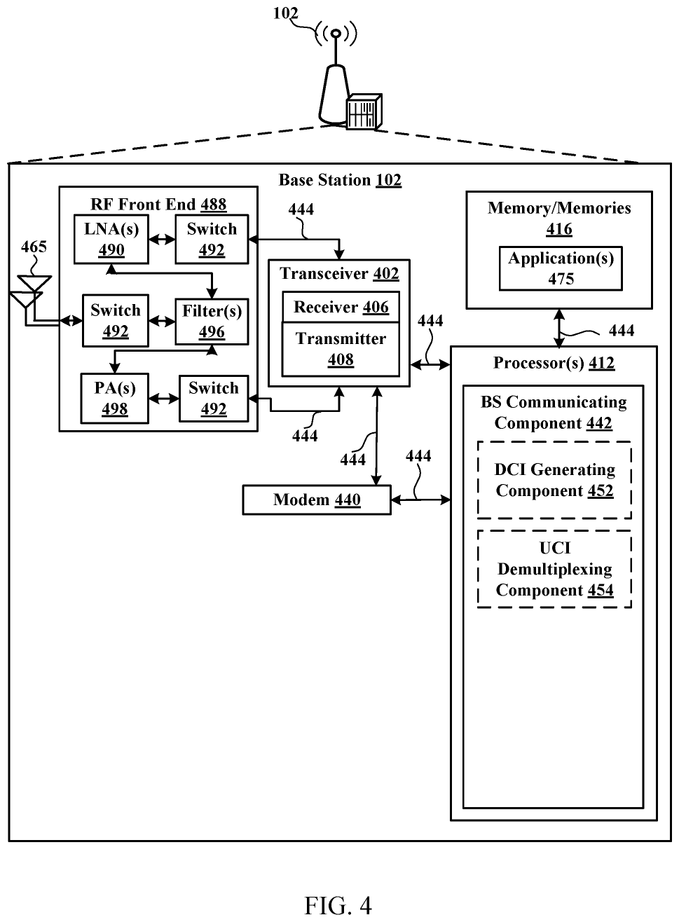

Referring to FIG. 4, one example of an implementation of base station 102 (e.g., a base station 102 and/or gNB 180, as described above) may include a variety of components, some of which have already been described above, but including components such as one or more processors 412 and one or more memories 416 and one or more transceivers 402 in communication via one or more buses 444. For example, the one or more processors 412 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 416 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 412, one or more memories 416, and one or more transceivers 402 may operate in conjunction with modem 440 and/or BS communicating component 442 for demultiplexing UCI from an uplink control channel or an uplink shared channel based on a parameter in DCI, in accordance with aspects described herein.

The transceiver 402, receiver 406, transmitter 408, one or more processors 412, memory/memories 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a DCI generating component 452 for generating DCI for transmitting to a UE, where the DCI can include a parameter indicating whether to multiplex UCI with an uplink control channel or an uplink shared channel, and/or a UCI demultiplexing component 454 for indicating whether to multiplex UCI in an uplink control channel or with an uplink shared channel.

In an aspect, the processor(s) 412 may correspond to one or more of the processors described in connection with the base station in FIG. 9. Similarly, the memory/memories 416 may correspond to the one or more memories described in connection with the base station in FIG. 9.

FIG. 5 illustrates a flow chart of an example of a method 500 for multiplexing UCI in an uplink control channel or with an uplink shared channel, in accordance with aspects described herein. FIG. 6 illustrates a flow chart of an example of a method 600 for indicating whether to multiplex UCI in an uplink control channel or with an uplink shared channel, in accordance with aspects described herein. In an example, a UE 104 can perform the functions described in method 500 shown in FIG. 5 using one or more of the components described in FIGS. 1 and/or 3. In an example, a node scheduling the UE 104 with communication resources, such as a base station 102 or gNB 180, a monolithic base station or gNB, a portion of a disaggregated base station or gNB, a UE in sidelink communication, etc., can perform the functions described in method 600 shown in FIG. 6 using one or more of the components described in FIGS. 1 and/or 4. Methods 500 and 600 are described in conjunction with one another for ease of explanation; however, the methods 500 and 600 are not required to be performed together and indeed can be performed independently using separate devices.

In method 600, at Block 602, DCI including a parameter having a value indicating whether UCI is to be multiplexed with an uplink control channel or an uplink shared channel can be generated. In an aspect, DCI generating component 452, e.g., in conjunction with processor(s) 412, memory/memories 416, transceiver 402, BS communicating component 442, etc., can generating the DCI including the parameter having the value indicating whether UCI is to be multiplexed with an uplink control channel (e.g., PUCCH) or an uplink shared channel (e.g., PUSCH). For example, DCI generating component 452 can generate the DCI for the UE 104, where the DCI can include a scheduling DCI that can include a resource grant (e.g., an uplink grant or downlink grant) of resources for the UE 104 to use in transmitting or receiving wireless communications.

In an example, DCI generating component 452 can determine whether the UE 104 is to multiplex the UCI in PUCCH or with PUSCH based on PUCCH and/or PUSCH resources that are being scheduled for the UE 104. For example, DCI generating component 452 can determine whether one PUCCH resource scheduled for the UE 104 is sufficient to carry multiplexed UCI expected to be transmitted by the UE 104 (e.g., UCI including HARQ-ACK feedback for downlink transmissions to the UE 104). In an example (e.g., if there is not a scheduled PUCCH resource sufficient to carry the multiplexed UCI), DCI generating component 452 can determine that UCI is to be multiplexed over PUSCH instead of PUCCH. In either case, DCI generating component 452 can generate a DCI for the UE 104 (e.g., to schedule PUCCH or PUSCH resources) that includes the parameter indicating whether to multiplex UCI over PUCCH or PUSCH. In one example, DCI generating component 452 may also determine which PUCCH or PUSCH to use for transmitting multiplexed UCI, and can include the parameter in the DCI that schedules the determined PUCCH or PUSCH.

In method 600, at Block 604, the DCI can be transmitted to the UE. In an aspect, DCI generating component 452, e.g., in conjunction with processor(s) 412, memory/memories 416, transceiver 402, BS communicating component 442, etc., can transmit the DCI to the UE 104. For example, DCI generating component 452 can transmit the DCI to the UE 104 over a downlink control channel (e.g., physical downlink control channel (PDCCH)), downlink shared channel (e.g., physical downlink shared channel (PDSCH)), etc. The DCI can include a DCI formatted based on a DCI format indicated in the wireless communication technology (e.g., DCI formats in 5G NR or similar technology).

In method 500, at Block 502, DCI including a parameter having a value indicating whether UCI is to be multiplexed with an uplink control channel or an uplink shared channel can be received from a network node. In an aspect, DCI processing component 352, e.g., in conjunction with processor(s) 312, memory/memories 316, transceiver 302, UE communicating component 342, etc., can receive, from the network node (e.g., base station 102) and/or process, the DCI including the parameter having the value indicating whether UCI is to be multiplexed with an uplink control channel (e.g., PUCCH) or an uplink shared channel (e.g., PUSCH). For example, DCI processing component 352 can receive the DCI in a PDCCH or PDSCH transmitted by the network node.

In method 500, at Block 504, UCI can be multiplexed, based on the value, UCI with one of the uplink control channel or the uplink shared channel. In an aspect, UCI multiplexing component 354, e.g., in conjunction with processor(s) 312, memory/memories 316, transceiver 302, UE communicating component 342, etc., can multiplex, based on the value of the parameter, the UCI with one of the uplink control channel (e.g., PUCCH) or the uplink shared channel (e.g., PUSCH). For example, the UE 104 can have multiple UCI values or instances (e.g., multiple HARQ-ACK feedback bits for multiple downlink transmission) to transmit to the network node.

Where the value of the parameter indicates to multiplex UCI with the uplink control channel, UCI multiplexing component 354 can multiplex the various UCI values or instances in one or more PUCCH resource. In one example, as described in further detail herein, UCI multiplexing component 354 can select the PUCCH resource(s) for multiplexing the UCI based on the DCI having the parameter, based on another parameter indicating the PUCCH resource(s), based on computing the PUCCH resource(s) using an algorithm, etc., as described in various examples herein.

Where the value of the parameter indicates to multiplex UCI with the uplink shared channel, UCI multiplexing component 354 can multiplex the various UCI values or instances in one or more PUSCH resources. In one example, as described in further detail herein, UCI multiplexing component 354 can select the PUSCH resource(s) for multiplexing the UCI based on the DCI having the parameter, based on another parameter indicating the PUSCH resource(s), based on computing the PUSCH resource(s) using an algorithm, etc., as described in various examples herein.

In method 500, at Block 506, one of the uplink control channel or the uplink shared channel multiplexed with the UCI can be transmitted. In an aspect, UCI multiplexing component 354, e.g., in conjunction with processor(s) 312, memory/memories 316, transceiver 302, UE communicating component 342, etc., can transmit one of the uplink control channel or the uplink shared channel multiplexed with the UCI. For example, UCI multiplexing component 354 can transmit the uplink control channel (e.g., PUCCH) or uplink shared channel (e.g., PUSCH) over associated resources, which can be transmitted to and/or received by the network node, as described above and in other examples herein.

In various examples described herein, the parameter used in the DCI can include a single bit indicator, which can be a newly defined bit in the DCI format, a reserved bit, or some other existing bit, where one value indicates to multiplex UCI on PUCCH and the other value indicates to multiplex UCI on PUSCH. In some examples, other side information can be provided as well to multiplex the UCI or determine the PUCCH resource(s) over which to multiplex the UCI. In other examples, the parameter used in the DCI can include a DAI already defined in the DCI format, where a value of zero can indicate to multiplex UCI on PUCCH and other values can indicate to multiple UCI on PUSCH and/or the other values can also be used for their intended purpose, as described further herein.

In an example, the network node can also receive and demultiplex the UCI based on the parameter indicated in the DCI. The demultiplexing is described herein in conjunction with the multiplexing for ease of explanation; however, aspects described herein do not require both of the multiplexing and demultiplexing functions to be performed or configured. For example, in method 600, optionally at Block 606, UCI multiplexed with one of the uplink control channel or the uplink shared channel can be received from the UE. In an aspect, UCI demultiplexing component 454, e.g., in conjunction with processor(s) 412, memory/memories 416, transceiver 402, BS communicating component 442, etc., can receive, from the UE (e.g., UE 104), UCI multiplexed with one of the uplink control channel (e.g., PUCCH) or uplink shared channel (e.g., PUSCH). For example, UCI demultiplexing component 454 can receive the PUCCH or PUSCH according to resource scheduled for transmitting the PUCCH or

PUSCH as indicated in a DCI transmitted to the UE 104. In addition, for example, UCI demultiplexing component 454 can know or determine which PUCCH or PUSCH includes the multiplexed UCI based on the DCI it generated that includes the parameter indicating whether to multiplex UCI with PUCCH or PUSCH, or based on otherwise computing or determining which PUCCH or PUSCH resource includes multiplexed UCI, as described herein.

In this example, in method 600, optionally at Block 608, UCI can be demultiplexed from one of the uplink control channel or the uplink shared channel based on the value. In an aspect, UCI demultiplexing component 454, e.g., in conjunction with processor(s) 412, memory/memories 416, transceiver 402, BS communicating component 442, etc., can demultiplex, based on the value of the parameter, UCI from one of the uplink control channel or the uplink shared channel. In addition, in method 600, optionally at Block 610, the UCI can be processed. In an aspect, BS communicating component 442, e.g., in conjunction with processor(s) 412, memory/memories 416, transceiver 402, etc., can process the UCI. For example, BS communicating component 442 can process various HARQ-ACK feedback values indicated in the multiplexed UCI to determine whether to retransmit any downlink communications, or can process other various UCI values that may be multiplexed (e.g., channel state information (CSI), scheduling request (SR), etc.).

In some examples, where the parameter includes a bit indicator in the DCI that indicates to multiplex UCI with PUSCH (e.g., bit value of ‘1’), UCI multiplexing component 354 can multiplex the UCI on the PUSCH that is scheduled by the DCI. Otherwise, UCI multiplexing component 354 may not multiplex the UCI on this PUSCH. In an example, where no PUSCHs scheduled in a slot have the parameter indicating to multiplex UCI with PUSCH (e.g., bit value of ‘1’), UCI multiplexing component 354 can multiplex UCI on PUCCH. Where UCI multiplexing component 354 detects at least one PUSCH (e.g., in a slot) having a parameter indicating to multiplex UCI, UCI multiplexing component 354 can use slot-based multiplexing or PUSCH boundary-based multiplexing.

For example, in multiplexing the UCI at Block 504, optionally at Block 508, the UCI can be multiplexed on PUCCHs scheduled or configured in a same slot as the uplink shared channel. In an aspect, UCI multiplexing component 354, e.g., in conjunction with processor(s) 312, memory/memories 316, transceiver 302, UE communicating component 342, etc., can multiplex the UCI on PUCCHs scheduled or configured in the same slot as the uplink shared channel (referred to as slot-based multiplexing). For example, given the DCI scheduling the PUSCH that includes the parameter value indicating to multiplex UCI on the PUSCH, UCI multiplexing component 354 can multiplex UCI scheduled on PUCCH resources in the same slot to instead be transmitted with the PUSCH that is scheduled by the DCI including the parameter value. This can reduce ambiguity due to missing DCI (e.g., if the DCI is missed, the UCI may not be multiplexed).

In an example, in demultiplexing the UCI at Block 608, optionally at Block 610, the UCI can be demultiplexed for PUCCHs scheduled or configured in a same slot as the uplink shared channel. In an aspect, UCI demultiplexing component 454, e.g., in conjunction with processor(s) 412, memory/memories 416, transceiver 402, BS communicating component 442, etc., can demultiplex the UCI for PUCCHs scheduled or configured in the same slot as the uplink shared channel. For example, given the DCI scheduling the PUSCH that includes the parameter value indicating to multiplex UCI on the PUSCH, UCI demultiplexing component 454 can demultiplex, from the PUSCH, UCI that was scheduled on PUCCH resources in the same slot as the PUSCH.

For example, in multiplexing the UCI at Block 504, optionally at Block 510, the UCI can be multiplexed on PUCCHs that overlap in time with the uplink shared channel. In an aspect, UCI multiplexing component 354, e.g., in conjunction with processor(s) 312, memory/memories 316, transceiver 302, UE communicating component 342, etc., can multiplex the UCI on PUCCHs that overlap in time (e.g., in the time domain) with the uplink shared channel (referred to as boundary-based multiplexing). For example, given the DCI scheduling the PUSCH that includes the parameter value indicating to multiplex UCI on the PUSCH, UCI multiplexing component 354 can multiplex UCI scheduled on PUCCH resources that overlap in time with the PUSCH that is scheduled by the DCI including the parameter value. This can reduce unnecessary multiplexing of UCIs.

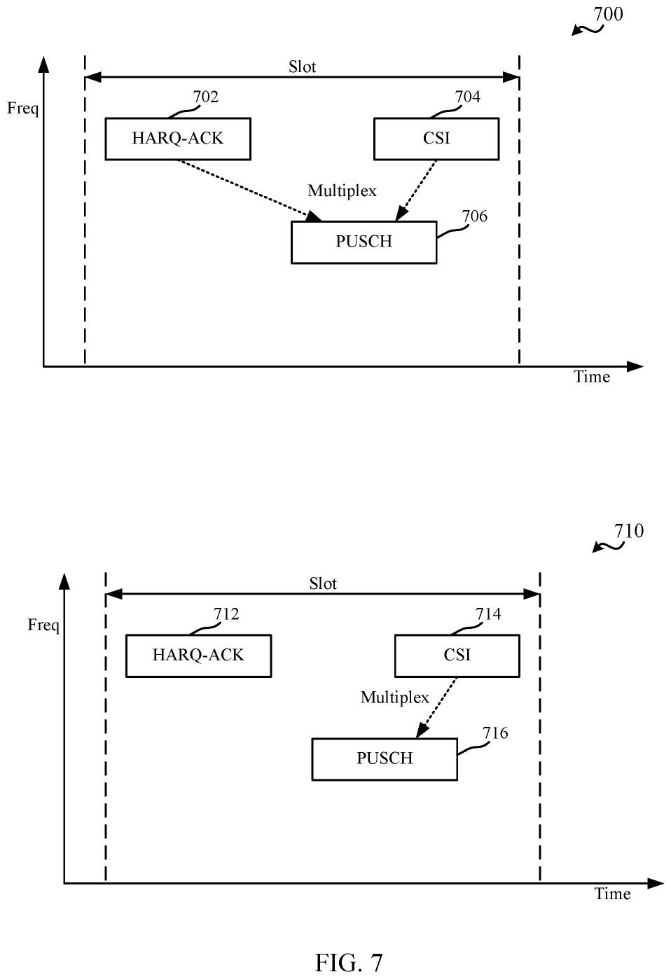

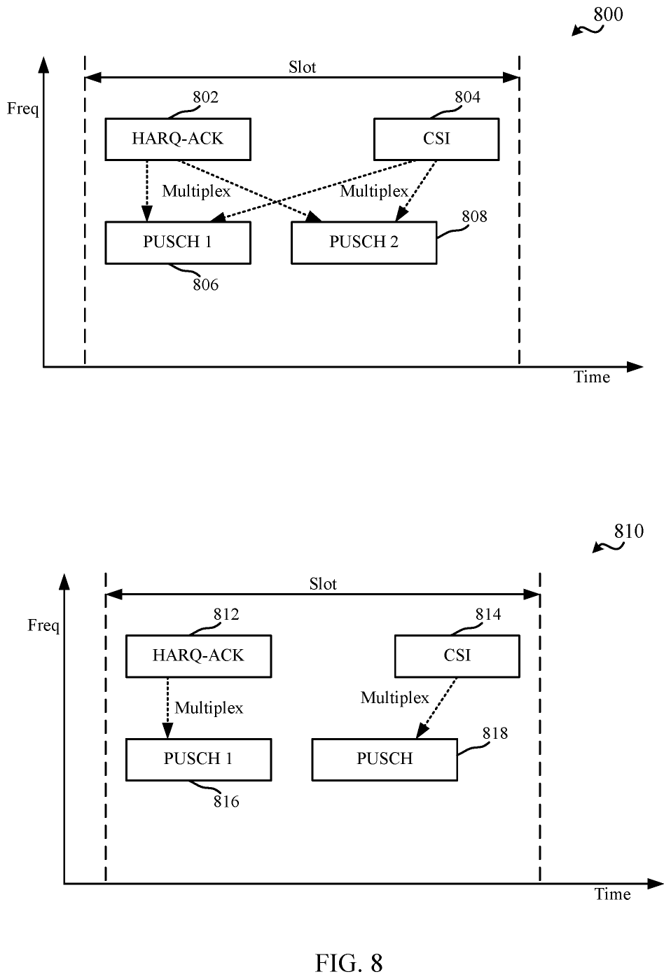

In an example, in demultiplexing the UCI at Block 608, optionally at Block 612, the UCI can be demultiplexed for PUCCHs that overlap in time with the uplink shared channel. In an aspect, UCI demultiplexing component 454, e.g., in conjunction with processor(s) 412, memory/memories 416, transceiver 402, BS communicating component 442, etc., can demultiplex the UCI for PUCCHs that overlap in time with the uplink shared channel. For example, given the DCI scheduling the PUSCH that includes the parameter value indicating to multiplex UCI on the PUSCH, UCI demultiplexing component 454 can demultiplex, from the PUSCH, UCI that was scheduled on PUCCH resources that overlap in time with the PUSCH. Examples of slot-based and boundary-based multiplexing are shown in FIGS. 7 and 8.

FIG. 7 illustrates examples of resource allocations 700, 710 for multiplexing UCI on an uplink shared channel, in accordance with aspects described herein. In resource allocation 700, the network node can schedule, for the UE, time and frequency resources for uplink communications, including a PUCCH resource allocation for HARQ-ACK 702, a PUCCH resource allocation for CSI 704, and a resource allocation for PUSCH 706. In one example, PUSCH 706 can be scheduled by a DCI that includes the parameter value indicating to multiplex UCI on the PUSCH 706. UCI multiplexing component 354 can accordingly determine, for slot-based multiplexing, to multiplex the UCI scheduled for transmission in the PUCCH resource allocation for HARQ-ACK 702 and the PUCCH resource allocation for CSI 704 with the PUSCH 706 transmission.

In resource allocation 710, the network node can schedule, for the UE, time and frequency resources for uplink communications, including a PUCCH resource allocation for HARQ-ACK 712, a PUCCH resource allocation for CSI 714, and a resource allocation for PUSCH 716. In one example, PUSCH 716 can be scheduled by a DCI that includes the parameter value indicating to multiplex UCI on the PUSCH 716. UCI multiplexing component 354 can accordingly determine, for boundary-based multiplexing, to multiplex the UCI scheduled for transmission in the PUCCH resource allocation for CSI 714 with the PUSCH 716 transmission. The UE 104 can separately transmit the UCI scheduled for transmission in the PUCCH resource allocation for HARQ-ACK 712.

FIG. 8 illustrates examples of resource allocations 800, 810 for multiplexing UCI on multiple uplink shared channels, in accordance with aspects described herein. In resource allocation 800, the network node can schedule, for the UE, time and frequency resources for uplink communications, including a PUCCH resource allocation for HARQ-ACK 802, a PUCCH resource allocation for CSI 804, and two resource allocations for PUSCH 806 and 808. In one example, PUSCHs 806 and 808 can be scheduled by a DCI that includes the parameter value indicating to multiplex UCI on the PUSCHs 806 and 808. UCI multiplexing component 354 can accordingly determine, for slot-based multiplexing, to multiplex the UCI scheduled for transmission in the PUCCH resource allocation for HARQ-ACK 802 and the PUCCH resource allocation for CSI 804 with the PUSCH 806 transmission and the PUSCH 808 transmission, such that each UCI is repeated and multiplexed on each of the multiple PUSCHs.

In resource allocation 810, the network node can schedule, for the UE, time and frequency resources for uplink communications, including a PUCCH resource allocation for HARQ-ACK 812, a PUCCH resource allocation for CSI 814, and two resource allocations for PUSCH 816 and 818. In one example, PUSCHs 816 and 818 can be scheduled by a DCI that includes the parameter value indicating to multiplex UCI on the PUSCHs 816 and 818. UCI multiplexing component 354 can accordingly determine, for boundary-based multiplexing, to multiplex the UCI scheduled for transmission in the PUCCH resource allocation for HARQ-ACK 812 with the PUSCH 816 transmission and multiplex the UCI scheduled for transmission in the PUCCH resource allocation for CSI 814 with the PUSCH 818 transmission. In these examples, the UCI rate matching, resource element (RE) mapping, etc., can follow a beta factor for each individual PUSCH 816 and 818.

In addition, in an example, UCI multiplexing with uplink shared channel, as described above and further herein, may be restricted to be used for UCI that is scheduled in a PUCCH resource that is in a same component carrier (CC) or intra-band contiguous carrier aggregation (CA) with the PUSCH resources with which to multiplex the UCI. For example, for PUCCH and PUSCH transmissions that are across different CCs (and/or are not intra-band contiguous CA), the UE 104 can perform parallel transmissions of PUCCH and PUSCH across CCs. Thus, in one example, multiplexing the UCI at Block 504, and/or demultiplexing UCI at Block 608, can be further based on (e.g., in addition to determinations corresponding to slot-based or boundary-based multiplexing) a determination that the UCI to be multiplexed/demultiplexed is scheduled in a PUCCH resource that is in the same CC or intra-band contiguous CA with the corresponding PUSCH resource.

Where the value of the parameter indicates to multiplex UCI with the uplink control channel, UCI multiplexing component 354 can multiplex the various UCI values or instances in one or more PUCCH resources. In one example, as described in further detail herein, UCI multiplexing component 354 can select the PUCCH resource(s) for multiplexing the UCI based on the DCI having the parameter, based on another parameter indicating the PUCCH resource(s), based on computing the PUCCH resource(s) using an algorithm, etc., as described in various examples herein. In an example, the DCI with the parameter indicating to multiplex UCI may correspond to a DCI scheduling PDSCH to which the UCI corresponds. In one example, the PUCCH resource determination for multiplexing the UCI can be a non-iterative procedure decoupled from UCI size.

In method 500, optionally at Block 512, resources can be selected for the uplink control channel over which to multiplex UCI. In an aspect, UCI multiplexing component 354, e.g., in conjunction with processor(s) 312, memory/memories 316, transceiver 302, UE communicating component 342, etc., can select the resources for the uplink control channel (e.g., PUCCH resources) over which to multiplex the UCI. For example, as described, UCI scheduled in multiple different PUCCH resources can be multiplexed in a single PUCCH resource for transmission. For example, the multiplexed UCI can correspond to UCI scheduled for transmission in a same slot. UCI multiplexing component 354 can select the resources based on various considerations or determinations, such as selecting a resource that is dedicated for UCI multiplexing, selecting resources from a pool of resources dedicated for UCI multiplexing, etc.

For example, UCI multiplexing component 354 can receive, from the network node, an indication of a dedicated PUCCH for UCI multiplexing. For example, DCI processing component 352 can process DCI to obtain PRI for scheduled PUCCH resources to determine the frequency and/or time resources of the PUCCH resources. In other examples, UE communicating component 342 can obtain RRC configuration of PUCCH resources. In any case, for configured or scheduled PUCCH resources, UCI multiplexing component 354 determine whether PUCCH resources overlap or not, and if so, UCI multiplexing component 354 can select the dedicated resources for multiplexing the UCI in the PUCCH resources that overlap in time. In some examples, as similarly described above with respect to PUSCH multiplexing, UCI multiplexing component 354 can multiplex, with the dedicated resources, UCI scheduled in the PUCCH resources in the slot (slot-based multiplexing) or UCI scheduled in the PUCCH resources that overlap in time with the dedicated resources (boundary-based multiplexing).

In one example, in multiplexing the UCI at Block 504, optionally at Block 514, multiple UCIs within a slot can be multiplexed with the uplink control channel. In an aspect, UCI multiplexing component 354, e.g., in conjunction with processor(s) 312, memory/memories 316, transceiver 302, UE communicating component 342, etc., can multiplex, with the uplink control channel (e.g., in PUCCH resources associated with one of the UCIs), the multiple UCIs within the slot. In another example, in multiplexing the UCI at Block 504, optionally at Block 516, a portion of multiple UCIs within a slot that overlap with the uplink control channel in time can be multiplexed with the uplink control channel (e.g., slot-based multiplexing). In an aspect, UCI multiplexing component 354, e.g., in conjunction with processor(s) 312, memory/memories 316, transceiver 302, UE communicating component 342, etc., can multiplex, with the uplink control channel (e.g., in PUCCH resources associated with one of the UCIs), a portion of multiple UCIs within the slot that overlap the uplink control channel (e.g., the selected PUCCH resources) in time (e.g., boundary-based multiplexing). In any case, in the dedicated PUCCH resource, the number of resource blocks (RBs) in the frequency domain can be increased as the merged UCI payload size increases, and/or may be bound by a maximum number of RBs configured by the network.

In method 600, optionally at Block 614, resources can be selected for the uplink control channel from which to demultiplex UCI. In an aspect, UCI demultiplexing component 454, e.g., in conjunction with processor(s) 412, memory/memories 416, transceiver 402, BS communicating component 442, etc., can select the resources for the uplink control channel (e.g., PUCCH resources) from which to demultiplex the UCI. For example, as described, UCI scheduled in multiple different PUCCH resources can be demultiplexed from a single PUCCH resource as received. For example, the multiplexed UCI can correspond to UCI scheduled for transmission in a same slot. UCI demultiplexing component 454 can select the resources based on various considerations or determinations, such as selecting a resource that is dedicated for UCI multiplexing, selecting resources from a pool of resources dedicated for UCI multiplexing, etc.

For example, UCI demultiplexing component 454 can transmit, to the UE, an indication of a dedicated PUCCH for UCI multiplexing. For configured or scheduled PUCCH resources, UCI demultiplexing component 454 determine whether PUCCH resources overlap or not, and if so, UCI demultiplexing component 4d54 can select the dedicated resources for demultiplexing the UCI from the PUCCH resources that overlap in time.

In one example, in demultiplexing the UCI at Block 606, optionally at Block 616, multiple UCIs within a slot can be demultiplexed from the uplink control channel. In an aspect, UCI demultiplexing component 454, e.g., in conjunction with processor(s) 412, memory/memories 416, transceiver 402, BS communicating component 442, etc., can demultiplex, from the uplink control channel (e.g., in PUCCH resources associated with one of the UCIs), the multiple UCIs within the slot. In another example, in demultiplexing the UCI at Block 606, optionally at Block 618, a portion of multiple UCIs within a slot that overlap with the uplink control channel in time can be demultiplexed from the uplink control channel (e.g., where the UCI is slot-based multiplexed). In an aspect, UCI demultiplexing component 454, e.g., in conjunction with processor(s) 412, memory/memories 416, transceiver 402, BS communicating component 442, etc., can demultiplex, from the uplink control channel (e.g., in PUCCH resources associated with one of the UCIs), a portion of multiple UCIs within the slot that overlap the uplink control channel (e.g., the selected PUCCH resources) in time (e.g., where the UCI is boundary-based multiplexed).

In another example, a resource pool of dedicated PUCCH resources for UCI multiplexing can be defined. In this example, in selecting the resources at Block 512, DCI processing component 352 can obtain the parameter from the DCI scheduling a PDSCH to determine whether PUCCH multiplexing is indicated. If not, the UE may expect that there are no scheduled PUCCH resources that overlap in time, and thus the UCI can be transmitted using time division multiplexing (TDM) using legacy resource pools for non-overlapping PUCCHs. If, however, the parameter does indicate PUCCH multiplexing, UCI multiplexing component 354 can select the PUCCH resources for multiplexing the UCI from the pool of dedicated PUCCH resources for UCI multiplexing based on the PRI indicated in the DCI. As described above, for example, UCI multiplexing component 354 can multiplex the UCI in the selected PUCCH resources using slot-based or boundary-based multiplexing (e.g., based on the slot or boundary of the selected PUCCH resources). In this example, the starting symbol, ending symbols, and starting PRB of the selected PUCCH resources may not change with merged UCI payload size, while the number of RBs (e.g., in frequency) may grow with the size of the merged UCI payload. In one example, if no DCI includes the UCI multiplexing parameter, UCI multiplexing component 354 can use a default resources (e.g., first resource) in the dedicated pool of resources for multiplexing the UCI. UCI demultiplexing component 454 can perform similar selection of the PUCCH resources from the dedicated PUCCH resource pool for demultiplexing the UCI.

In yet another example, a set indicator can be included in the DCI scheduling the PUCCH or scheduling the PDSCH for which PUCCH is expected. As described, in 5G NR, four sets of PUCCH resource pools are defined for transmitting UCI. In an example, in selecting the resources at Block 512, DCI processing component 352 can obtain the set indicator (e.g., a 2 bit set indicator capable of indicating one of the four PUCCH resource pools), and UCI multiplexing component 354 can select the PUCCH resources based on the set indicator. For example, UCI multiplexing component 354 can select the PUCCH resources by selecting the resource pool based on the set indicator and then selecting the resources from the resource pool based on the PRI. Similarly, for example, DCI generating component 452 can set the set indicator in the DCI, and UCI demultiplexing component 454 can demultiplex the UCI from PUCCH resources from the PUCCH resource pool indicated by the set indicator, and the PUCCH resources within the pool indicated by the PRI.

In another example, the parameter can be an uplink DAI, as defined in 5G NR, which can be used such that a value of zero can indicate to multiplex UCI on PUCCH and a value greater than zero can indicate to multiple UCI on PUSCH and/or to use the uplink DAI value for its intended purpose (e.g., to determine a number of HARQ-ACK bits to multiplex on the PUSCH). For example, the functionality of UL DAI defined in 5G NR can be to indicate the number of HARQ-ACK bits UE should mux on a PUSCH, e.g., 0, 1, 2, 3, determining to multiplex UCI on a PUSCH. If UCI is not multiplexed on a PUSCH, the UL DAI of that PUSCH can be obsolete. In accordance with aspects described herein, UL DAI can be used up front to decide whether UCI is multiplexed on PUCCH or PUSCH, and if it is transmitted on PUSCH, how many HARQ-ACK bits UE should multiplex.

For example, DCI processing component 352 can process DCIs to check DAIs of the scheduled PUSCHs in a slot. If none of the DAIs are greater than zero, UCI multiplexing can multiplex the UCI on a PUCCH resource (e.g., on a PUCCH resources of a primary CC, e.g., CC1). If the PUCCH resource does not overlap in time with a PUSCH resource on the same CC, UCI multiplexing component 354 can transmit the multiplexed UCI on the PUCCH resource. If the PUCCH resource does overlap in time with a PUSCH resource on the same CC, UCI multiplexing component 354 may drop the multiplexed UCI transmission due to scheduling error. If at least one UL DAI is greater than zero, UCI multiplexing component 354 can multiplex the UCI with the corresponding PUSCH(s). For example, if only one PUSCH DAI is greater than zero, UCI multiplexing component 354 can multiplex the UCI with that PUSCH. If multiple PUSCHs have DAI greater than zero, UCI multiplexing component 354 can multiplex the UCI (e.g., HARQ-ACK and/or CSI) on the multiple PUSCHs by repetition.

In this regard, for example, in multiplexing the UCI at Block 504, optionally at Block 518, UCI can be multiplexed with the uplink control channel based on none of the multiple DCI having DAI greater than zero. In an aspect, UCI multiplexing component 354, e.g., in conjunction with processor(s) 312, memory/memories 316, transceiver 302, UE communicating component 342, etc., can multiplex the UCI with the uplink control channel based on none of the multiple DCI having a DAI greater than zero. As described, DCI processing component 352 can obtain the DAI in DCI for each PUSCH to determine whether any of the DCI have DAI greater than zero. In addition, as described, UCI multiplexing component 354 can select PUCCH on a primary CC for transmitting the multiplexed UCI.

Similarly, for example, for example, in demultiplexing the UCI at Block 606, optionally at Block 620, UCI can be demultiplexed from the uplink control channel based on none of the multiple DCI having DAI greater than zero. In an aspect, UCI demultiplexing component 454, e.g., in conjunction with processor(s) 412, memory/memories 416, transceiver 402, BS communicating component 442, etc., can demultiplex the UCI with the uplink control channel based on none of the multiple DCI having a DAI greater than zero. As described, DCI generating component 452 can generate DCIs for PUSCH, which may not have DAI greater than zero, and UCI demultiplexing component 454 can determine to demultiplex UCI from PUCCH based on determining that none of the DCIs have DAI greater than zero. In addition, as described, UCI multiplexing component 354 can select PUCCH on a primary CC for demultiplexing UCI.

In another example, in multiplexing the UCI at Block 504, optionally at Block 520, UCI can be multiplexed with the uplink shared channel based on at least one of the multiple DCI having DAI greater than zero. In an aspect, UCI multiplexing component 354, e.g., in conjunction with processor(s) 312, memory/memories 316, transceiver 302, UE communicating component 342, etc., can multiplex the UCI with the uplink shared channel based on at least one of the multiple DCI having a DAI greater than zero. As described, DCI processing component 352 can obtain the DAI in DCI for each PUSCH to determine whether any of the DCI have DAI greater than zero, and if so, UCI multiplexing component 354 can multiplex the UCI with that/those PUSCH(s).

Similarly, for example, for example, in demultiplexing the UCI at Block 606, optionally at Block 622, UCI can be demultiplexed from the uplink control shared based on at least one of the multiple DCI having DAI greater than zero. In an aspect, UCI demultiplexing component 454, e.g., in conjunction with processor(s) 412, memory/memories 416, transceiver 402, BS communicating component 442, etc., can demultiplex the UCI from the uplink shared channel based on at least one of the multiple DCI having a DAI greater than zero. As described, DCI generating component 452 can generate DCIs for PUSCH, which may have DAI greater than zero, and UCI demultiplexing component 454 can determine to demultiplex UCI from PUSCH(s) based on determining which corresponding DCIs have DAI greater than zero.

In another example, in multiplexing the UCI at Block 504, optionally at Block 522, UCI can be multiplexed with a number of feedback bits indicated by the DAI. In an aspect, UCI multiplexing component 354, e.g., in conjunction with processor(s) 312, memory/memories 316, transceiver 302, UE communicating component 342, etc., can multiplex the UCI with the number of feedback bits indicated by the DAI. Similarly, for example, for example, in demultiplexing the UCI at Block 606, optionally at Block 624, UCI can be demultiplexed from the number of feedback bits indicated by the DAI. In an aspect, UCI demultiplexing component 454, e.g., in conjunction with processor(s) 412, memory/memories 416, transceiver 402, BS communicating component 442, etc., can demultiplex the UCI from the number of feedback bits indicated by the DAI. In one example, the code points for the DAI can be remapped based on using DAI=0 to indicate UCI multiplexing with PUCCH (or otherwise not multiplexing UCI on PUSCH).

For example, the DAI defined in 5G NR can be two bits, used to represent 4 values (e.g., 0, 1, 2, 3) using a modular four operation. In 5G NR, each value can represent the number of bits to multiplex as being the indicated value plus 4n, where n can be a non-negative integer (e.g., 0, 1, 2, . . . ). In accordance with aspects described herein, when using DAI=0 to indicate UCI multiplexing with PUCCH, the code point values for DAI can be remapped to not use zero (e.g., using a modular three operation, such that the value indicates to multiplex the indicated value plus 3n). For example, DAI=1 can indicate to multiplex 1, 4, 7, . . . feedback bits, DAI=2 can indicate to multiplex 2, 5, 8, . . . feedback bits, DAI=3 can indicate to multiplex 3, 6, 9, . . . feedback bits.

In another example, to improve the robustness of UL DAI against missing DL DCIs (e.g., where modular 3 cannot be recovered if missing 3 DL DCIs back-to-back), UL DAI field can be extended to 3 bits, which can allow for a modular 8 operation. In this example, DAI=0 can be used to indicate UCI multiplexing on PUCCH (or otherwise not multiplexing UCI on PUSCH), DAI=1 can indicate to multiplex 1, 8, 15, . . . feedback bits, DAI=2 can indicate to multiplex 2, 9, 16, . . . feedback bits, DAI=3 can indicate to multiplex 3, 10, 17, . . . feedback bits, DAI=4 can indicate to multiplex 4, 11, 18, . . . feedback bits, DAI=5 can indicate to multiplex 5, 12, 19, . . . feedback bits, DAI=6 can indicate to multiplex 6, 13, 20, . . . feedback bits, DAI=7 can indicate to multiplex 7, 14, 21, . . . feedback bits. The number of feedback bits to multiplex can be distinguished based on the number of received downlink grants and associated DAIs.

In any case, UCI multiplexing component 354 can determine the number of feedback bits to multiplex with PUSCH based on the DAI value, where the DAI value is greater than zero, using the DAI value and the appropriate modular 3 (or modular 8) operation, as described above. Similarly, UCI demultiplexing component 454 can determine the number of feedback bits to demultiplex from PUSCH based on the DAI value, where the DAI value is greater than zero, using the DAI value and the appropriate modular 3 (or modular 8) operation, as described above.

FIG. 9 is a block diagram of a MIMO communication system 900 including a base station 102 and a UE 104. The MIMO communication system 900 may illustrate aspects of the wireless communication access network 100 described with reference to FIG. 1. The base station 102 may be an example of aspects of the base station 102 described with reference to FIG. 1. The base station 102 may be equipped with antennas 934 and 935, and the UE 104 may be equipped with antennas 952 and 953. In the MIMO communication system 900, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 920 may receive data from a data source. The transmit processor 920 may process the data. The transmit processor 920 may also generate control symbols or reference symbols. A transmit MIMO processor 930 may perform spatial processing (e.g., precoding) on data symbols, control symbols, or reference symbols, if applicable, and may provide output symbol streams to the transmit modulator/demodulators 932 and 933. Each modulator/demodulator 932 through 933 may process a respective output symbol stream (e.g., for OFDM, etc.) to obtain an output sample stream. Each modulator/demodulator 932 through 933 may further process (e.g., convert to analog, amplify, filter, and upconvert) the output sample stream to obtain a DL signal. In one example, DL signals from modulator/demodulators 932 and 933 may be transmitted via the antennas 934 and 935, respectively.

The UE 104 may be an example of aspects of the UEs 104 described with reference to FIGS. 1 and 3. At the UE 104, the UE antennas 952 and 953 may receive the DL signals from the base station 102 and may provide the received signals to the modulator/demodulators 954 and 955, respectively. Each modulator/demodulator 954 through 955 may condition (e.g., filter, amplify, downconvert, and digitize) a respective received signal to obtain input samples. Each modulator/demodulator 954 through 955 may further process the input samples (e.g., for OFDM, etc.) to obtain received symbols. A MIMO detector 956 may obtain received symbols from the modulator/demodulators 954 and 955, perform MIMO detection on the received symbols, if applicable, and provide detected symbols. A receive (Rx) processor 958 may process (e.g., demodulate, deinterleave, and decode) the detected symbols, providing decoded data for the UE 104 to a data output, and provide decoded control information to a processor(s) 980, or memory/memories 982.

The processor(s) 980 may in some cases execute stored instructions to instantiate a UE communicating component 342 (see e.g., FIGS. 1 and 3).

On the uplink (UL), at the UE 104, a transmit processor 964 may receive and process data from a data source. The transmit processor 964 may also generate reference symbols for a reference signal. The symbols from the transmit processor 964 may be precoded by a transmit MIMO processor 966 if applicable, further processed by the modulator/demodulators 954 and 955 (e.g., for single carrier-FDMA, etc.), and be transmitted to the base station 102 in accordance with the communication parameters received from the base station 102. At the base station 102, the UL signals from the UE 104 may be received by the antennas 934 and 935, processed by the modulator/demodulators 932 and 933, detected by a MIMO detector 936 if applicable, and further processed by a receive processor 938. The receive processor 938 may provide decoded data to a data output and to the processor(s) 940 or memory/memories 942.

The processor(s) 940 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 900. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 900.

The following aspects are illustrative only and aspects thereof may be combined with aspects of other embodiments or teaching described herein, without limitation.

Aspect 1 is a method for wireless communication at a UE including receiving, from a network node, DCI including a parameter having a value indicating whether UCI is to be multiplexed with an uplink control channel or an uplink shared channel, multiplexing, by the UE and based on the value, UCI with one of the uplink control channel or the uplink shared channel, and transmitting one of the uplink control channel or the uplink shared channel multiplexed with the UCI.

In Aspect 2, the method of Aspect 1 includes where the parameter includes a single bit indicator having the value indicating whether UCI is to be multiplexed with the uplink control channel or the uplink shared channel.

In Aspect 3, the method of any of Aspects 1 or 2 includes where the parameter indicates UCI is to be multiplexed with the uplink shared channel, and where multiplexing, with the uplink shared channel, the UCI includes multiplexing the UCI on PUCCHs scheduled or configured in a same slot as the uplink shared channel.

In Aspect 4, the method of any of Aspects 1 to 3 includes where the parameter indicates UCI is to be multiplexed with the uplink shared channel, and where multiplexing, with the uplink shared channel, the UCI includes multiplexing the UCI on PUCCHs that overlap in time with the uplink shared channel.

In Aspect 5, the method of any of Aspects 1 to 4 includes where the parameter indicates UCI is to be multiplexed with the uplink shared channel, and where multiplexing the UCI includes multiplexing, with each of multiple uplink shared channels, multiple UCIs on PUCCHs scheduled or configured in a same slot as multiple the uplink shared channels.

In Aspect 6, the method of any of Aspects 1 to 5 includes where the parameter indicates UCI is to be multiplexed with the uplink shared channel, and where multiplexing the UCI includes multiplexing, with the uplink shared channel in a slot, the UCI scheduled or configured on a first PUCCH in the slot that overlaps in time with the uplink shared channel, and multiplexing, with a second uplink shared channel in the slot, a second UCI scheduled or configured on a second PUCCH that overlaps in time with the second uplink shared channel.

In Aspect 7, the method of any of Aspects 1 to 6 includes where multiplexing the UCI with the uplink shared channel is based at least in part on the UCI and uplink shared channel being associated with a same CC or being associated with different CCs in intra-band continuous carrier aggregation.

In Aspect 8, the method of any of Aspects 1 to 7 includes where multiplexing the UCI includes multiplexing the UCI with the uplink control channel, where the parameter indicates UCI is to be multiplexed with the uplink control channel, and where the uplink control channel is dedicated for UCI multiplexing.

In Aspect 9, the method of Aspect 8 includes where multiplexing the UCI with the uplink control channel dedicated for UCI multiplexing is based at least in part on detecting multiple UCIs within a slot.

In Aspect 10, the method of Aspect 9 includes where multiplexing the UCI with the uplink control channel dedicated for UCI multiplexing includes multiplexing, with the uplink control channel, the multiple UCIs within the slot.

In Aspect 11, the method of any of Aspects 9 or 10 includes where multiplexing the UCI with the uplink control channel dedicated for UCI multiplexing includes multiplexing, with the uplink control channel, a portion of the multiple UCIs within the slot that overlap the uplink control channel in time.

In Aspect 12, the method of any of Aspects 1 to 11 includes where multiplexing the UCI includes multiplexing the UCI with the uplink control channel, where the parameter indicates UCI is to be multiplexed with the uplink control channel, and selecting resources for the uplink control channel from a pool of uplink control channel resources dedicated for UCI multiplexing.

In Aspect 13, the method of Aspect 12 includes where selecting the resources for the uplink control channel is based on a physical uplink control channel resource indicator (PRI) value specified in the DCI.

In Aspect 14, the method of any of Aspects 12 or 13 includes where multiplexing the UCI with the uplink control channel includes multiplexing, with the uplink control channel, multiple UCIs within a slot.

In Aspect 15, the method of any of Aspects 12 to 14 includes where multiplexing the UCI with the uplink control channel includes multiplexing, with the uplink control channel, a portion of multiple UCIs within a slot that overlap the uplink control channel in time.

In Aspect 16, the method of any of Aspects 12 to 15 includes where selecting the resources for the uplink control channel is based on a set indicator value and a PRI value specified in the DCI, where the set indicator value indicates one of multiple sets of uplink control channel resources, and the PRI value indicates the uplink control channel in the one of the multiple sets of uplink control channel resources.

In Aspect 17, the method of any of Aspects 1 to 16 includes where the parameter is an uplink downlink assignment index (DAI), and where the uplink DAI having a value of zero indicates to not multiplex the UCI with the uplink shared channel, and where the uplink DAI having a value of greater than zero indicates to multiplex the UCI with the uplink shared channel.

In Aspect 18, the method of any of Aspects 1 to 17 includes where receiving the DCI includes receiving multiple DCI for multiple uplink shared channels, and where multiplexing the UCI includes one of multiplexing the UCI with the uplink control channel based at least in part on none of the multiple DCI having an uplink DAI greater than zero or multiplexing the UCI with the uplink shared channel based at least in part on at least one of the multiple DCI having an uplink DAI greater than zero.

In Aspect 19, the method of Aspect 18 includes where the uplink shared channel is one of the at least one of the multiple DCI having the uplink DAI greater than zero.

In Aspect 20, the method of any of Aspects 18 or 19 includes where multiplexing the UCI with the uplink shared channel includes multiplexing the UCI with a number of feedback bits indicated at least in part by the DAI, where the number of feedback bits is indicated at least in part by the DAI with a modulo operation based on a maximum value for the DAI minus 1.

In Aspect 21, the method of any of Aspects 1 to 20 includes where the DCI corresponds to one of a downlink grant or an uplink grant.

Aspect 22 is a method for wireless communication at a network node including generating DCI including a parameter having a value indicating whether UCI is to be multiplexed with an uplink control channel or an uplink shared channel, and transmitting, for a UE, the DCI.

In Aspect 23, the method of Aspect 22 includes where the parameter includes a single bit indicator having the value indicating whether UCI is to be multiplexed with the uplink control channel or the uplink shared channel.

In Aspect 24, the method of any of Aspects 22 or 23 includes where the parameter indicates UCI is to be multiplexed with the uplink shared channel, and receiving, from the UE, UCI multiplexed with the uplink shared channel, and demultiplexing, based on the parameter, the UCI from PUCCHs scheduled or configured in a same slot as the uplink shared channel.

In Aspect 25, the method of any of Aspects 22 to 24 includes where the parameter indicates UCI is to be multiplexed with the uplink shared channel, and receiving, from the UE, UCI multiplexed with the uplink shared channel, and demultiplexing, based on the parameter, the UCI from PUCCHs that overlap in time with the uplink shared channel.

In Aspect 26, the method of any of Aspects 22 to 25 includes where the parameter indicates UCI is to be multiplexed with the uplink shared channel, and receiving, from the UE, UCI multiplexed with the uplink shared channel, and demultiplexing, from each of multiple uplink shared channels and based on the parameter, multiple UCIs on PUCCHs scheduled or configured in a same slot as multiple the uplink shared channels.

In Aspect 27, the method of any of Aspects 22 to 26 includes where the parameter indicates UCI is to be multiplexed with the uplink shared channel, and receiving, from the UE, UCI multiplexed with one of the uplink control channel or the uplink shared channel. demultiplexing, from the uplink shared channel in a slot and based on the parameter, the UCI scheduled or configured on a first PUCCH in the slot that overlaps in time with the uplink shared channel; and demultiplexing, from a second uplink shared channel in the slot and based on the parameter, a second UCI scheduled or configured on a second PUCCH that overlaps in time with the second uplink shared channel.

In Aspect 28, the method of any of Aspects 22 to 27 includes receiving, from the UE, UCI multiplexed with one of the uplink control channel or the uplink shared channel, and demultiplexing, based on the parameter, the UCI from the uplink shared channel based at least in part on the UCI and uplink shared channel being associated with a same CC or being associated with different CCs in intra-band continuous carrier aggregation.

In Aspect 29, the method of any of Aspects 22 to 28 includes receiving, from the UE, UCI multiplexed with one of the uplink control channel or the uplink shared channel, and demultiplexing, based on the parameter, the UCI from the uplink control channel, where the parameter indicates UCI is to be multiplexed with the uplink control channel, and where the uplink control channel is dedicated for UCI multiplexing.

In Aspect 30, the method of Aspect 29 includes where demultiplexing the UCI from the uplink control channel dedicated for UCI multiplexing is based at least in part on scheduling multiple UCIs within a slot.

In Aspect 31, the method of Aspect 30 includes where demultiplexing the UCI from the uplink control channel dedicated for UCI multiplexing includes demultiplexing, from the uplink control channel, the multiple UCIs within the slot.

In Aspect 32, the method of any of Aspects 30 or 31 includes where demultiplexing the UCI from the uplink control channel dedicated for UCI multiplexing includes demultiplexing, from the uplink control channel, a portion of the multiple UCIs within the slot that overlap the uplink control channel in time.

In Aspect 33, the method of any of Aspects 22 to 32 includes receiving, from the UE, UCI multiplexed with the uplink control channel, and demultiplexing, based on the parameter, the UCI from the uplink control channel, where the parameter indicates UCI is to be multiplexed with the uplink control channel, and where the uplink control channel is in resources selected from a pool of uplink control channel resources dedicated for UCI multiplexing.

In Aspect 34, the method of Aspect 33 includes where the DCI includes PRI value indicating the resources to be selected from the pool of uplink control channel resources dedicated for UCI multiplexing.

In Aspect 35, the method of any of Aspects 33 or 34 includes where demultiplexing the UCI from the uplink control channel includes demultiplexing, from the uplink control channel, multiple UCIs within a slot.

In Aspect 36, the method of any of Aspects 33 to 35 includes where demultiplexing the UCI from the uplink control channel includes demultiplexing, from the uplink control channel, a portion of multiple UCIs within a slot that overlap the uplink control channel in time.

In Aspect 37, the method of any of Aspects 33 to 36 includes where the DCI includes a set indicator value and a PRI value, where the set indicator value indicates one of multiple sets of uplink control channel resources, and the PRI value indicates the uplink control channel in the one of the multiple sets of uplink control channel resources.

In Aspect 38, the method of any of Aspects 22 to 37 includes where the parameter is an uplink DAI, and where the uplink DAI having a value of zero indicates to multiplex the UCI with the uplink control channel, and where the uplink DAI having a value of greater than zero indicates to multiplex the UCI with the uplink shared channel.

In Aspect 39, the method of any of Aspects 22 to 38 includes where transmitting the DCI includes transmitting multiple DCI for multiple uplink shared channels, and receiving, from the UE, UCI multiplexed with uplink control channel, and demultiplexing, based on the parameter, the UCI from the uplink control channel based at least in part on none of the multiple DCI having an uplink downlink assignment index (DAI) greater than zero or demultiplexing, based on the parameter, the UCI from the uplink shared channel based at least in part on at least one of the multiple DCI having an uplink DAI greater than zero.

In Aspect 40, the method of Aspect 39 includes where the uplink shared channel is one of the at least one of the multiple DCI having the uplink DAI greater than zero.

In Aspect 41, the method of any of Aspects 39 or 40 includes where demultiplexing the UCI from the uplink shared channel includes demultiplexing the UCI with a number of feedback bits indicated at least in part by the DAI, where the number of feedback bits is indicated at least in part by the DAI with a modulo operation based on a maximum value for the DAI minus 1.

In Aspect 42, the method of any of Aspects 22 to 41 includes where the DCI corresponds to one of a downlink grant or an uplink grant.

Aspect 43 is an apparatus for wireless communication including one or more processors, one or more memories coupled with the one or more processors, and instructions stored in the one or more memories and operable, when executed by the one or more processors, to cause the apparatus to perform any of the methods of Aspects 1 to 42.

Aspect 44 is an apparatus for wireless communication including means for performing any of the methods of Aspects 1 to 42.

Aspect 45 is one or more computer-readable media including code executable by one or more processors for wireless communications, the code including code for performing any of the methods of Aspects 1 to 42.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
receive, from a network node, downlink control information (DCI) including a parameter having a value indicating whether uplink control information (UCI) is to be multiplexed with an uplink control channel or an uplink shared channel;
multiplex, based on the value, UCI with one of the uplink control channel or the uplink shared channel; and
transmit one of the uplink control channel or the uplink shared channel multiplexed with the UCI.

2. The apparatus of claim 1, wherein the parameter includes a single bit indicator having the value indicating whether UCI is to be multiplexed with the uplink control channel or the uplink shared channel.

3. The apparatus of claim 1, wherein the parameter indicates UCI is to be multiplexed with the uplink shared channel, and wherein the one or more processors are, individually or in combination, configured to execute the instructions to cause the apparatus to multiplex, with the uplink shared channel, the UCI on physical uplink control channels (PUCCHs) scheduled or configured in a same slot as the uplink shared channel.

4. The apparatus of claim 1, wherein the parameter indicates UCI is to be multiplexed with the uplink shared channel, and wherein the one or more processors are, individually or in combination, configured to execute the instructions to cause the apparatus to multiplex, with the uplink shared channel, the UCI on physical uplink control channels (PUCCHs) that overlap in time with the uplink shared channel.

5. The apparatus of claim 1, wherein the parameter indicates UCI is to be multiplexed with the uplink shared channel, and wherein the one or more processors are, individually or in combination, configured to execute the instructions to cause the apparatus to multiplex, with each of multiple uplink shared channels, multiple UCIs on physical uplink control channels (PUCCHs) scheduled or configured in a same slot as multiple the uplink shared channels.

6. The apparatus of claim 1, wherein the parameter indicates UCI is to be multiplexed with the uplink shared channel, and wherein the one or more processors are, individually or in combination, configured to execute the instructions to cause the apparatus to multiplex, with the uplink shared channel in a slot, the UCI scheduled or configured on a first physical uplink control channel (PUCCH) in the slot that overlaps in time with the uplink shared channel, and multiplex, with a second uplink shared channel in the slot, a second UCI scheduled or configured on a second PUCCH that overlaps in time with the second uplink shared channel.

7. The apparatus of claim 1, wherein the one or more processors are, individually or in combination, configured to execute the instructions to cause the apparatus to multiplex the UCI with the uplink shared channel based at least in part on the UCI and uplink shared channel being associated with a same component carrier (CC) or being associated with different CCs in intra-band continuous carrier aggregation.

8. The apparatus of claim 1, wherein the one or more processors are, individually or in combination, configured to execute the instructions to cause the apparatus to multiplex the UCI with the uplink control channel, wherein the parameter indicates UCI is to be multiplexed with the uplink control channel, and wherein the uplink control channel is dedicated for UCI multiplexing.

9. The apparatus of claim 8, wherein the one or more processors are, individually or in combination, configured to execute the instructions to cause the apparatus to multiplex the UCI with the uplink control channel dedicated for UCI multiplexing based at least in part on detecting multiple UCIs within a slot.

10. The apparatus of claim 9, wherein the one or more processors are, individually or in combination, configured to execute the instructions to cause the apparatus to multiplex, with the uplink control channel, the multiple UCIs within the slot.

11. The apparatus of claim 9, wherein the one or more processors are, individually or in combination, configured to execute the instructions to cause the apparatus to multiplex, with the uplink control channel, a portion of the multiple UCIs within the slot that overlap the uplink control channel in time.

12. The apparatus of claim 1, wherein the one or more processors are, individually or in combination, configured to execute the instructions to cause the apparatus to multiplex the UCI with the uplink control channel, wherein the parameter indicates UCI is to be multiplexed with the uplink control channel, and wherein the one or more processors are, individually or in combination, configured to execute the instructions to cause the apparatus to select resources for the uplink control channel from a pool of uplink control channel resources dedicated for UCI multiplexing.

13. The apparatus of claim 12, wherein the one or more processors are, individually or in combination, configured to execute the instructions to cause the apparatus to select the resources for the uplink control channel based on a physical uplink control channel resource indicator (PRI) value specified in the DCI.

14. The apparatus of claim 12, wherein the one or more processors are, individually or in combination, configured to execute the instructions to cause the apparatus to multiplex, with the uplink control channel, multiple UCIs within a slot.

15. The apparatus of claim 12, wherein the one or more processors are, individually or in combination, configured to execute the instructions to cause the apparatus to multiplex, with the uplink control channel, a portion of multiple UCIs within a slot that overlap the uplink control channel in time.

16. The apparatus of claim 12, wherein the one or more processors are, individually or in combination, configured to execute the instructions to cause the apparatus to select the resources for the uplink control channel based on a set indicator value and a physical uplink control channel resource indicator (PRI) value specified in the DCI, wherein the set indicator value indicates one of multiple sets of uplink control channel resources, and the PRI value indicates the uplink control channel in the one of the multiple sets of uplink control channel resources.

17. The apparatus of claim 1, wherein the parameter is an uplink downlink assignment index (DAI), and wherein the uplink DAI having a value of zero indicates to not multiplex the UCI with the uplink shared channel, and wherein the uplink DAI having a value of greater than zero indicates to multiplex the UCI with the uplink shared channel.

18. The apparatus of claim 1, wherein the one or more processors are, individually or in combination, configured to execute the instructions to cause the apparatus to receive multiple DCI for multiple uplink shared channels, and wherein the one or more processors are, individually or in combination, configured to execute the instructions to cause the apparatus to one of multiplex the UCI with the uplink control channel based at least in part on none of the multiple DCI having an uplink downlink assignment index (DAI) greater than zero or multiplex the UCI with the uplink shared channel based at least in part on at least one of the multiple DCI having an uplink DAI greater than zero.

19. The apparatus of claim 18, wherein the uplink shared channel is one of the at least one of the multiple DCI having the uplink DAI greater than zero.

20. The apparatus of claim 18, wherein the one or more processors are, individually or in combination, configured to execute the instructions to cause the apparatus to multiplex the UCI with a number of feedback bits indicated at least in part by the DAI, wherein the number of feedback bits is indicated at least in part by the DAI with a modulo operation based on a maximum value for the DAI minus 1.

21. The apparatus of claim 1, wherein the DCI corresponds to one of a downlink grant or an uplink grant.

22. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
generate downlink control information (DCI) including a parameter having a value indicating whether uplink control information (UCI) is to be multiplexed with an uplink control channel or an uplink shared channel; and
transmit, for a user equipment (UE), the DCI.

23. The apparatus of claim 22, wherein the parameter includes a single bit indicator having the value indicating whether UCI is to be multiplexed with the uplink control channel or the uplink shared channel.

24. The apparatus of claim 22, wherein the parameter indicates UCI is to be multiplexed with the uplink shared channel, and wherein the one or more processors are, individually or in combination, configured to execute the instructions to cause the apparatus to:
receive, from the UE, UCI multiplexed with the uplink shared channel; and
demultiplex, based on the parameter, the UCI from physical uplink control channels (PUCCHs) scheduled or configured in a same slot as the uplink shared channel.

25. The apparatus of claim 22, wherein the parameter indicates UCI is to be multiplexed with the uplink shared channel, and wherein the one or more processors are, individually or in combination, configured to execute the instructions to cause the apparatus to:
receive, from the UE, UCI multiplexed with the uplink shared channel; and
demultiplex, based on the parameter, the UCI from physical uplink control channels (PUCCHs) that overlap in time with the uplink shared channel.

26. The apparatus of claim 22, wherein the parameter indicates UCI is to be multiplexed with the uplink shared channel, and wherein the one or more processors are, individually or in combination, configured to execute the instructions to cause the apparatus to:
receive, from the UE, UCI multiplexed with the uplink shared channel; and
demultiplex, from each of multiple uplink shared channels and based on the parameter, multiple UCIs on physical uplink control channels (PUCCHs) scheduled or configured in a same slot as multiple the uplink shared channels.

27. A method for wireless communication at a user equipment (UE), comprising:
receiving, from a network node, downlink control information (DCI) including a parameter having a value indicating whether uplink control information (UCI) is to be multiplexed with an uplink control channel or an uplink shared channel;
multiplexing, by the UE and based on the value, UCI with one of the uplink control channel or the uplink shared channel; and
transmitting one of the uplink control channel or the uplink shared channel multiplexed with the UCI.

28. The method of claim 27, wherein the parameter includes a single bit indicator having the value indicating whether UCI is to be multiplexed with the uplink control channel or the uplink shared channel.

29. A method for wireless communication at a network node, comprising:
generating downlink control information (DCI) including a parameter having a value indicating whether uplink control information (UCI) is to be multiplexed with an uplink control channel or an uplink shared channel; and
transmitting, for a user equipment (UE), the DCI.

30. The method of claim 29, wherein the parameter includes a single bit indicator having the value indicating whether UCI is to be multiplexed with the uplink control channel or the uplink shared channel.
